(19) United States
(12) Patent Application Publication
(10) Pub. No.: US 2018/0034854 A1
(43) Pub. Date: Feb. 1, 2018

(54) HYPERTEXT TRANSFER PROTOCOL SECURE (HTTPS) BASED PACKET PROCESSING METHODS AND APPARATUSES

(71) Applicant: ALIBABA GROUP HOLDING LIMITED, George Town (KY)

(72) Inventors: Lin GONG, Hangzhou (CN); Xianwei LIN, Hangzhou (CN); Haitao JIANG, Hangzhou (CN)

(73) Assignee: ALIBABA GROUP HOLDING LIMITED

(21) Appl. No.: 15/660,799

(22) Filed: Jul. 26, 2017

(30) Foreign Application Priority Data
Jul. 29, 2016 (CN) 201610618117.5

(51) Int. Cl. H04L 29/06

(52) U.S. Cl. CPC H04L 63/166; H04L 63/0442; H04L 63/0435; H04L 63/061

(57) ABSTRACT

The present application discloses hypertext transfer protocol secure (HTTPS) based packet processing methods and apparatuses. An exemplary method may include receiving an HTTPS request sent by a client terminal. The method may also include looking up in a key database in accordance with a target domain name in the HTTPS request, and reading a ciphertext of an encrypted first private key corresponding to the target domain name. The method may further include decrypting, by using a second private key, the ciphertext of the encrypted first private key to obtain the first private key; and decrypting, by using the first private key, a ciphertext of an encrypted symmetric key contained in the HTTPS request to obtain the symmetric key.

### CROSS REFERENCE TO RELATED APPLICATION

The present application claims the benefit of priority to Chinese Application No. 201610618117.5, filed Jul. 29, 2016, the entire contents of which are incorporated herein by reference.

### TECHNICAL FIELD

The present application relates to hypertext transfer protocol secure (HTTPS) based transmission technologies, and more particularly, to HTTPS-based packet processing methods and apparatuses.

### BACKGROUND

With rapid development of the Internet and cloud computing, there are plenty of services relying on network technologies and cloud computing. In networks, browsers on client terminals are widely used by users, such as a browser installed on a smartphone and a browser installed on a personal computer. Through a browser, a user may browse a web page, upload data to a server, and download data from the server. Considering security of data transmissions between a client terminal and a server, data communications between the client terminal and the server are conducted by using a hypertext transfer protocol over secure socket layer (HTTPS).

The HTTPS is a secure hypertext transfer protocol (HTTP) proposed based on the HTTP. The HTTP is a protocol layer above a transmission control protocol (TCP). The HTTPS further includes an encryption layer, a secure socket layer (SSL) or a transport layer security (TLS), between the HTTP and the TCP. From the perspective of a data transmitter, SSL/TLS is responsible for encrypting contents to be transmitted and delivering to the lower-layer TCP. In a data receiver, SSL/TLS is responsible for decrypting the transmitted contents from the TCP and restoring them into corresponding contents. However, with the increasing popularization of the Internet and cloud computing, risks of website domain names being attacked may rise dramatically. In particular, certain website domain names may suffer frequently from distributed denial-of-service (DDoS) attacks. Bandwidths of most websites may not be sufficient to overcome large-scale DDoS attacks. Those DDoS attacks may cause risks to security. In addition, most websites may not be able to effectively defend against numerous Web attacks, such as cross-site scripting (XSS) or structured query language (SQL) injection attacks.

Currently, in HTTPS-based encrypted data transmissions, HTTPS may need handshaking between a client terminal and a server before transmitting data to establish security keys, or numerical certificates, for the encrypted data transmissions. During the handshaking, the client terminal may send a connection request to the server. The server may respond with its certificate and information about the certificate to the client terminal. The client terminal may check whether the certificate sent by the server is issued by a trusted certificate authority (CA). If the certificate sent by the server is issued by a trusted certificate authority, the client terminal may proceed with handshaking. Otherwise, the client terminal may bring up a warning message and may wait for the user's confirmation before continuing to visit a website.

The client terminal may randomly generate a symmetric key for the encrypted data transmissions. For example, the data transmissions are encrypted in a symmetric encryption manner. The client terminal may then encrypt the symmetric key by using a public key of the server, and may send the encrypted symmetric key to the server. After the handshaking, the client terminal and the server may perform encrypted data transmissions accordingly. The client terminal and the server may decrypt the transmitted data by using the symmetric key, and may obtain a corresponding data packet after the decryption.

In the existing HTTPS-based data transmissions, the symmetric key can be generated by the client terminal and sent to the server. The client terminal can encrypt the symmetric key by using the public key of the server, and can send the encrypted symmetric key to the server in the form of ciphertext. The server can use a corresponding private key in a key pair to decrypt the encrypted symmetric key into a plaintext. During this process, however, if a firewall is set for the website, it may be needed to upload a private key of the website server, the private key for the client, to the firewall. Once the firewall of the website is hacked, however, there exists a risk of leaking the client private key. As a result, the client private key may not be secure.

### SUMMARY

The present disclosure relates to HTTPS-based packet processing methods and apparatuses to solve problems of low security of client private keys in current technologies.

In some aspects, the present disclosure is directed to an HTTPS-based packet processing method. The method may include receiving an HTTPS request sent by a client terminal. The method may also include looking up in a key database in accordance with a target domain name in the HTTPS request, and reading a ciphertext of an encrypted first private key corresponding to the target domain name. The method may further include decrypting, by using a second private key, the ciphertext of the encrypted first private key to obtain the first private key, and decrypting, by using the first private key, a ciphertext of an encrypted symmetric key contained in the HTTPS request to obtain the symmetric key.

In some embodiments, the method may be performed by a firewall.

In some embodiments, the ciphertext of the encrypted first private key may be obtained by encrypting the first private key using a second public key. The second private key and the second public key may belong to a key pair.

In some embodiments, encrypting the first private key may include encrypting the first private key in a network-isolated environment.

In some embodiments, the second private key and the second public key may be generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some embodiments, the symmetric key may be used in subsequent encrypted data transmission between the client terminal and a server.

In some aspects, the present disclosure is directed to an HTTPS-based packet processing apparatus. The apparatus may include an HTTPS-request receiving unit configured to receive an HTTPS request sent by a client terminal. The apparatus may also include a ciphertext reading unit configured to: look up in a key database in accordance with a target domain name in the HTTPS request, and read a ciphertext of an encrypted first private key corresponding to the target domain name. The apparatus may further include a private-key ciphertext decryption unit configured to decrypt, by using a second private key, the ciphertext of the encrypted first private key to obtain the first private key. In addition, the apparatus may include a symmetric-key ciphertext decryption unit configured to decrypt, by using the first private key, a ciphertext of an encrypted symmetric key contained in the HTTPS request to obtain the symmetric key.

In some aspects, the present disclosure is directed to another HTTPS-based packet processing method. The method may include receiving an HTTPS request sent by a client terminal. The method may also include decrypting, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal. The method may further include determining, by analyzing the data packet, whether a distributed denial-of-service (DDoS) attack on the target domain name exists. Responsive to the determination that the DDoS attack on the target domain name does not exist, the method may include sending the HTTPS request to a server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, responsive to the determination that the DDoS attack on the target domain name exists, determining whether the DDoS attack on the target domain name exists in the method may further include intercepting the HTTPS request, or sending a prompting message of the existence of the DDoS attack.

In some embodiments, the data packet may include visiting parameters for the target domain name. The visiting parameters may include traffic, a visitor IP address, and a visiting frequency.

In some embodiments, determining whether the DDoS attack on the target domain name exists in the method may include determining whether the traffic visiting the target domain name in a first time interval is greater than a traffic threshold. Responsive to the determination that the traffic visiting the target domain name in the first time interval is not greater than the traffic threshold, determining whether the DDoS attack on the target domain name exists in the method may also include sending the HTTPS request to the server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, receiving the HTTPS request sent by the client terminal may further include receiving a data request sent by the client terminal. Receiving the HTTPS request sent by the client terminal may also include determining whether a request type of the data request is the HTTPS request. Responsive to the determination that the request type of the data request is not the HTTPS request, receiving the HTTPS request sent by the client terminal may further include prohibiting the data request from visiting the target domain name, or intercepting the data request.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some aspects, the present disclosure is directed to an HTTPS-based packet processing apparatus. The apparatus may include an HTTPS-request receiving unit configured to receive an HTTPS request sent by a client terminal. The apparatus may also include an HTTPS-request decryption unit configured to decrypt, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal. The apparatus may further include a distributed denial-of-service (DDoS) attack determining unit configured to determine, by analyzing the data packet, whether a DDoS attack on the target domain name exists. Responsive to the determination that the DDoS attack on the target domain name does not exist, the DDoS attack determining unit may also be configured to activate an HTTPS-request sending unit. In addition, the apparatus may include the HTTPS-request sending unit configured to send the HTTPS request to a server corresponding to the target domain name.

In some aspects, the present disclosure relates to a network apparatus. The network apparatus may include a processor configured to receive a hypertext transfer protocol secure (HTTPS) request sent by a client terminal. The processor of the network apparatus may also be configured to look up in a key database in accordance with a target domain name in the HTTPS request, and read a ciphertext of an encrypted first private key corresponding to the target domain name. The processor of the network apparatus may further be configured to decrypt, by using a second private key, the ciphertext of the encrypted first private key to obtain the first private key; and decrypt, by using the first private key, a ciphertext of an encrypted symmetric key contained in the HTTPS request to obtain the symmetric key. The network apparatus may also include a storage device configured to store the ciphertext of the encrypted first private key and the ciphertext of the encrypted symmetric key.

In yet another aspect, the present disclosure is directed to another network apparatus. The network apparatus may include a processor configured to receive a hypertext transfer protocol secure (HTTPS) request sent by a client terminal. The processor of the network apparatus may also be configured to decrypt the HTTPS request by using a symmetric key in accordance with a target domain name in the HTTPS request to obtain a data packet. The processor of the network apparatus may further be configured to determine, by analyzing the data packet, whether a distributed denial-of-service (DDoS) attack on the target domain name exists. Responsive to the determination that the DDoS attack on the target domain name does not exist, the processor of the network apparatus may be configured to send the HTTPS request to a server corresponding to the target domain name. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal. The network apparatus may also include a storage device configured to store the target domain name, the data packet, the ciphertext of the encrypted first private key, and the ciphertext of the encrypted symmetric key.

In some aspects, the present disclosure is directed to a non-transitory computer readable medium that stores a set of instructions that is executable by at least one processor of an apparatus to cause the apparatus to perform a hypertext transfer protocol secure (HTTPS) based packet processing method. The method may include receiving an HTTPS request sent by a client terminal. The method may also include looking up in a key database in accordance with a target domain name in the HTTPS request, and reading a ciphertext of an encrypted first private key corresponding to the target domain name. The method may further include decrypting, by using a second private key, the ciphertext of the encrypted first private key to obtain the first private key, and decrypting, by using the first private key, a ciphertext of an encrypted symmetric key contained in the HTTPS request to obtain the symmetric key.

In some embodiments, the method in the non-transitory computer readable medium may be performed by a firewall.

In some embodiments, the ciphertext of the encrypted first private key may be obtained by encrypting the first private key using a second public key. The second private key and the second public key may belong to a key pair.

In some embodiments, encrypting the first private key may include encrypting the first private key in a network-isolated environment.

In some embodiments, the second private key and the second public key may be generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some embodiments, the symmetric key may be used in subsequent encrypted data transmission between the client terminal and a server.

In some aspects, the present disclosure is directed to another non-transitory computer readable medium that stores a set of instructions that is executable by at least one processor of an apparatus to cause the apparatus to perform another hypertext transfer protocol secure (HTTPS) based packet processing method. The method may include receiving an HTTPS request sent by a client terminal. The method may also include decrypting, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal. The method may further include determining, by analyzing the data packet, whether a distributed denial-of-service (DDoS) attack on the target domain name exists. Responsive to the determination that the DDoS attack on the target domain name does not exist, the method may include sending the HTTPS request to a server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, responsive to the determination that the DDoS attack on the target domain name exists, determining whether the DDoS attack on the target domain name exists in the method may further include intercepting the HTTPS request, or sending a prompting message of the existence of the DDoS attack.

In some embodiments, the data packet may include visiting parameters for the target domain name. The visiting parameters may include traffic, a visitor IP address, and a visiting frequency.

In some embodiments, determining whether the DDoS attack on the target domain name exists in the method may include determining whether the traffic visiting the target domain name in a first time interval is greater than a traffic threshold. Responsive to the determination that the traffic visiting the target domain name in the first time interval is not greater than the traffic threshold, determining whether the DDoS attack on the target domain name exists in the method may also include sending the HTTPS request to the server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, receiving the HTTPS request sent by the client terminal may further include receiving a data request sent by the client terminal. Receiving the HTTPS request sent by the client terminal may also include determining whether a request type of the data request is the HTTPS request. Responsive to the determination that the request type of the data request is not the HTTPS request, receiving the HTTPS request sent by the client terminal may further include prohibiting the data request from visiting the target domain name, or intercepting the data request.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

As compared with the existing technologies, the embodiments described in the present disclosure may provide the following advantages. The HTTPS-based packet processing method in the present disclosure may include receiving an HTTPS request sent by a client terminal. The method may also include looking up in a key database in accordance with a target domain name in the HTTPS request, and reading a ciphertext of an encrypted first private key corresponding to the target domain name. The method may further include decrypting, by using a second private key, the ciphertext of the encrypted first private key to obtain the first private key; and decrypting, by using the first private key, a ciphertext of an encrypted symmetric key contained in the HTTPS request to obtain the symmetric key.

Another HTTPS-based packet processing method in the present disclosure may include receiving an HTTPS request sent by a client terminal. The method may also include decrypting, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal.

In these HTTPS-based packet processing methods, the first private key may be encrypted as the ciphertext of the encrypted first private key, and may be stored in such a form. In other words, a private key of a client may be encrypted into a ciphertext, and may be stored in the form of ciphertext, reducing the risk of leaking the private key of the client.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a schematic diagram of an exemplary application scenario of an HTTPS-based packet processing method, according to some embodiments of the present disclosure.

FIG. 2 is a flowchart of an exemplary HTTPS-based packet processing method, according to some embodiments of the present disclosure.

FIG. 3 is a schematic diagram of an exemplary HTTPS-based packet processing apparatus, according to some embodiments of the present disclosure.

FIG. 4 is a flowchart of another exemplary HTTPS-based packet processing method, according to some embodiments of the present disclosure.

FIG. 5 is a schematic diagram of an exemplary HTTPS-based packet processing apparatus, according to some embodiments of the present disclosure.

FIG. 6 is a schematic diagram of an exemplary network apparatus, according to some embodiments of the present disclosure.

FIG. 7 is a schematic diagram of another exemplary network apparatus, according to some embodiments of the present disclosure.

### DETAILED DESCRIPTION

Many details are illustrated in the following descriptions to facilitate a comprehensive understanding of the present disclosure. Methods and apparatuses in the present disclosure may be implemented in many other ways different from these described herein. Those skilled in the art may make similar extensions without departing from the connotation of the present disclosure. Therefore, the present disclosure is not limited to specific implementations disclosed in the following.

The present disclosure provides an HTTPS-based packet processing method. The present disclosure also provides an HTTPS-based packet processing apparatus, another HTTPS-based packet processing method and apparatus, and two network apparatuses. These methods and apparatuses are described in detail below with reference to the drawings of the embodiments. Steps of the methods are also respectively illustrated below.

The present disclosure includes an HTTPS-based packet processing method as follows:

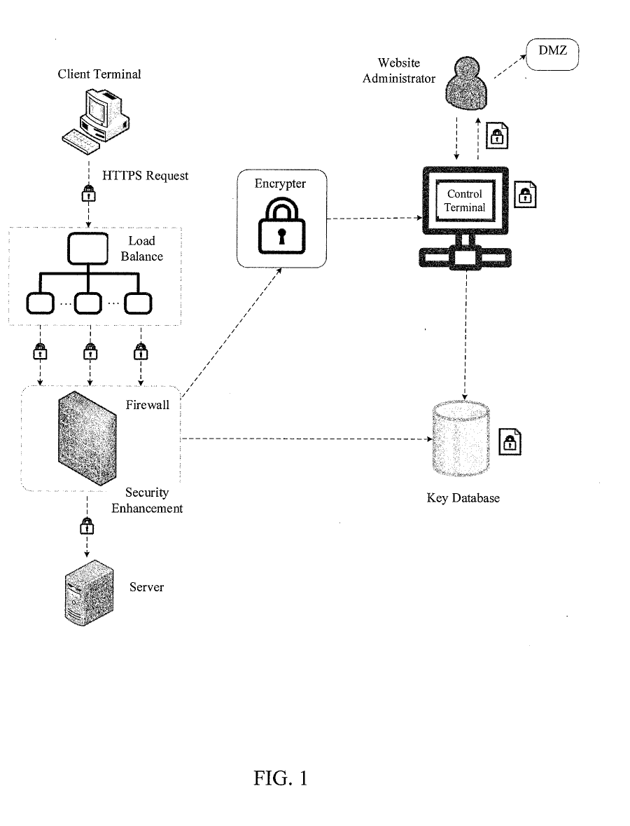

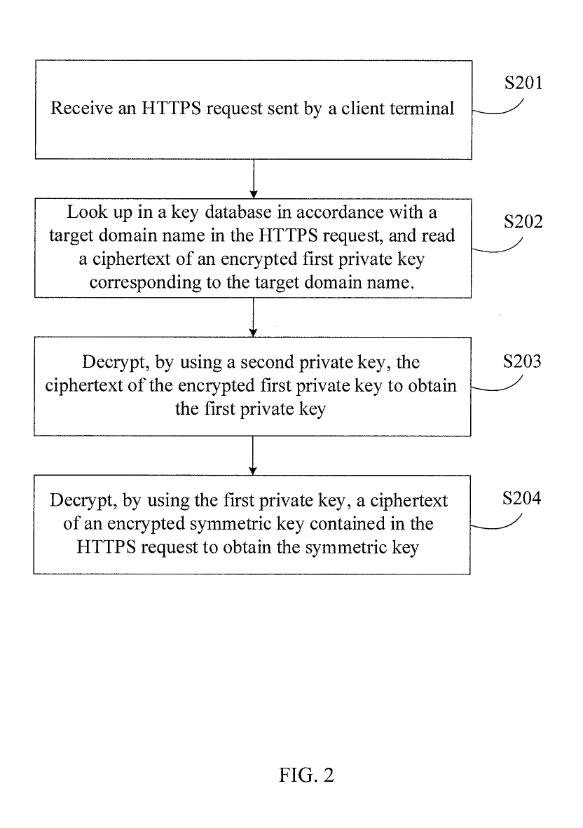

FIG. 1 is a schematic diagram of an exemplary application scenario of an HTTPS-based packet processing method, according to some embodiments of the present disclosure. FIG. 2 is a flowchart of an exemplary HTTPS-based packet processing method, according to some embodiments of the present disclosure. In addition, relationships among steps of the HTTPS-based packet processing methods may be determined according to FIG. 2.

Step S201: Receive an HTTPS request sent by a client terminal.

In existing HTTPS-based encrypted data transmissions, before transmitting encrypted data between a client terminal and a server, handshaking between the client terminal and the server may be conducted to agree on a symmetric key for subsequent encrypted data transmissions. After the handshaking, the client terminal and the server may respectively encrypt transmitted data by using the symmetric key. A data transmitter, or an encryption side, may encrypt plaintext data into corresponding ciphertext data by using the symmetric key. A data receiver, or a decryption side, may decrypt the ciphertext data into the corresponding plaintext data by using the symmetric key.

However, when a firewall is set on the server, a private key on the server may need to be uploaded to the firewall to decrypt the symmetric key. In other words, a private key of a client may be uploaded to the firewall, and therefore at the risk of being leaked. The present disclosure provides an HTTPS-based packet processing method. On the basis of the existing HTTPS-based data transmissions, the HTTPS-based packet processing method may include encrypting the private key of the client when uploading the private key to the firewall and/or when the firewall uses and stores the private key to reduce the risk of leaking the private key.

Accordingly, the firewall of the server may carry out the HTTPS-based packet processing method, such as a firewall shown in FIG. 1. Nonetheless, in practical applications, the HTTPS-based packet processing method may not be limited to being carried out by the firewall, but may also be carried out by many types of execution entities. For example, an intrusion detection system (IDS) configured on the server may carry out the HTTPS-based packet processing method. Various entities that carry out the HTTPS-based packet processing method may slightly change some details, and may not depart from the main concepts of the method disclosed in the present disclosure. Therefore, those various entities that carry out the method and their implementation variants are still in the scope of the present disclosure.

The HTTPS request in the present disclosure may refer to a packet request sent by the client terminal to the server after the handshaking between the client terminal and the server. The HTTPS request may include the ciphertext of the encrypted symmetric key that is agreed between the client terminal and the server.

This step includes receiving the HTTPS request sent by the client terminal. The HTTPS request may include information about a domain name of a website currently visited by the client terminal. For example, the server firewall shown in FIG. 1 may receive an HTTPS request sent by a browser on the client terminal.

Step S202: Look up in a key database in accordance with a target domain name in the HTTPS request, and read a ciphertext of an encrypted first private key corresponding to the target domain name.

In some embodiments, the target domain name may refer to a domain name of a website currently visited by the client terminal. As described above, the HTTPS request may include the information about the domain name of the website currently visited by the client terminal. Therefore, the domain name of the website currently visited by the client terminal (i.e., the target domain name) may be determined in accordance with the information about the domain name of the website.

The ciphertext of the encrypted first private key may be the first private key in the form of a ciphertext after being encrypted. There may also exist a first public key corresponding to the first private key. The first private key and the first public key may belong to a key pair. In some embodiments, the first private key may refer to a private key on the server. In some embodiments, a private key may be corresponding to a website of a client terminal. In some embodiments, the first public key may refer to a public key on the server. In some embodiments, a public key may be corresponding to the website of the client terminal.

In some embodiments, to reduce the risk of leaking the first private key, the encryption process of the first private key may be performed in a network-isolated environment. In some embodiments, the encryption process may be performed by a website administrator on the client terminal. For example, as shown in FIG. 1, the website administrator may encrypt the first private key in a demilitarized zone (DMZ) to obtain the ciphertext of the encrypted first private key. The DMZ may be a buffer area set up between an insecure system and a secure system to solve the problem that an external client terminal cannot access an internal server terminal after the firewall is installed. Compared with a conventional firewall, the DMZ may serve as another checkpoint for a client terminal outside the firewall, and therefore may ensure the security of the server effectively.

In some embodiments, the first public key and the first private key on the server may be unique. In other words, a first public key and a first private key corresponding to any website may be unique. On this basis, the first public key and the first private key corresponding to any target domain name visited by the client terminal may also be unique. The target domain name may have a unique correspondence with the first private key, and may also have a unique correspondence with the ciphertext of the encrypted first private key. Therefore, for any target domain name visited by the client terminal, the method may include determining the first private key and/or the first public key that uniquely correspond to the target domain name.

In some embodiments, it may be needed to prevent first private keys respectively corresponding to a plurality of target domain names from being temporarily stored in a machine deployed at the firewall, and/or to improve performance of the machine deployed at the firewall. The first private keys respectively corresponding to the target domain names may be stored in a key database to reduce the numbers of the first private keys and the ciphertexts of the encrypted first private keys temporarily stored in the machine deployed at the firewall, and to improve processing efficiency of the machine. In some embodiments, the first private key may be stored in the key database in the form of the encrypted ciphertext (i.e. the ciphertext of the encrypted first private key). Therefore, even if a hacker may intrude the key database and obtain the ciphertext of the private key for the client terminal, the hacker may not be able to decrypt the ciphertext of the private key. It may reduce the risk of leaking the private key.

In some embodiments, before the first key may be stored in the key database, the method may further include the following steps to prevent the first private key from being stored in the key database in the form of plaintext.

The method may include determining whether the first private key exists in the form of the ciphertext of the encrypted first private key. In response to the first private key exists in the form of the ciphertext, the method may also include storing the ciphertext of the encrypted first private key in the key database. In response to the first private key does not exist in the form of the ciphertext, the method may further include encrypting the first private key into the ciphertext of the encrypted first private key by using the second public key.

In some embodiments, security on the machine deployed at the firewall may be further enhanced to reduce the risk of the firewall being hacked. It may reduce the risk of leaking the private key at the firewall. For example, the method may include removing an operation entry for operating data in the memory of the machine deployed at the firewall, as shown in FIG. 1.

As described above, the first private key may be encrypted by the website administrator on the client terminal in a network-isolated environment. After obtaining the ciphertext of the encrypted first private key, the website administrator may upload the ciphertext of the encrypted first private key. After being uploaded, the ciphertext of the encrypted first private key may be stored in the key database. For example, as shown in FIG. 1, the website administrator may upload the ciphertext of the encrypted first private key to a control terminal. The control terminal may store the ciphertext of the encrypted first private key in the key database. The control terminal may refer to a console of a cloud shield, in which records of remote logins of a website administrator, login IP addresses, locations, and login times may be seen. It may be possible to find out an account name of a malicious login person through the console of a cloud shield. The risk of leaking the private key for the client terminal may be reduced by login control enhancement.

In this step, the ciphertext of the encrypted first private key corresponding to the target domain name may be looked up in the key database. The found ciphertext of the encrypted first private key may be read to prepare for decryption of the ciphertext of the encrypted first private key in Step S203 below.

Step S203: Decrypt, by using a second private key, the ciphertext of the encrypted first private key to obtain the first private key.

The HTTPS-based packet processing method in the present disclosure may include encryption and decryption of the first private key to avoid leakage of the first private key. In particular, the ciphertext of the encrypted first private key may be obtained by encrypting the first private key using the second public key. On the contrary, the first private key may be obtained by decrypting the ciphertext of the encrypted first private key using the second private key. The second private key and the second public key may belong to a key pair. The second private key and the second public key may match each other.

In some embodiments, the second public key and the second private key in the second key pair may be generated by an encryptor. For example, the second key pair may be generated by a host encryption apparatus authenticated and approved by a national commercial cipher administration, such as the encryptor shown in FIG. 1. In some embodiments, after the encryptor may generate the second public key, the second public key may further be output from the encryptor to the control terminal, and may be obtained from the control terminal before encrypting the first private key. When encrypting the first private key, the client terminal may download the second public key from the control terminal. The second public key may be known by the firewall only. Therefore, even if the private key database storing the first private key is hacked, the hacker may only obtain the ciphertext of the encrypted first private key, and may not be able to decrypt the ciphertext of the encrypted first private key.

In some embodiments, the first private key and the ciphertext of the encrypted first private key may be unique, and may have a unique correspondence with the target domain name. On this basis, the second public key for encrypting the first private key may also be unique, and therefore may be uniquely corresponding to the target domain name. Moreover, the second private key for decrypting the ciphertext of the encrypted first private key may be unique, and may also be uniquely corresponding to the target domain name.

In this step, the ciphertext of the encrypted first private key read in Step S202 may be decrypted, by using the second private key, to obtain the first private key to prepare for decryption of the ciphertext of the encrypted symmetric key in Step S204 below.

Step S204: Decrypt, by using the first private key, a ciphertext of an encrypted symmetric key contained in the HTTPS request to obtain the symmetric key.

The symmetric key may refer to a key that is agreed on between the client terminal and the server terminal during the handshaking. The symmetry key may be included in the HTTPS request sent by the client terminal to the server terminal. In some embodiments, the symmetric key may be used for encrypted data transmissions between the client terminal and the server.

In some embodiments, when the data transmissions between the client terminal and the server are encrypted by using the symmetric key, the method may include a symmetric encryption. For example, when the client terminal may send encrypted data to the server, the client terminal may encrypt the data by using a symmetric key, and may send the ciphertext of the encrypted data to the server terminal. The server may decrypt the received ciphertext of the encrypted data by using the symmetric key to obtain the transmitted data in plaintext. In some embodiments, when the server may send encrypted data to the client terminal, the server may encrypt the data by using a symmetric key, and may send the ciphertext of the encrypted data to the client terminal. The client terminal may decrypt the received ciphertext of the encrypted data by using the symmetric key to obtain the transmitted data in plaintext.

Accordingly, the HTTPS-based packet processing method may include determining, according to a received HTTPS request, a target domain name to be visited by a client terminal. The method may also include looking up and reading, in a key database, the ciphertext of the encrypted first private key corresponding to the target domain name. The method may further include decrypting the ciphertext of the encrypted first private key to be a first private key in the form of plaintext by using a second private key. In addition, the method may include decrypting, by using the first private key obtained after the decryption, the ciphertext of the encrypted symmetric key included in the HTTPS request to obtain the symmetric key. In some embodiments, the first private key may be encrypted into the ciphertext of the encrypted first private key, and may be stored in the form of the ciphertext of the encrypted first private key. In other words, a private key for a client terminal may be encrypted into the ciphertext, and may be stored in the form of a ciphertext, thereby reducing the risk of leaking the private key for the client terminal.

In some embodiments, the HTTPS-based packet processing method may be performed by a firewall.

In some embodiments, the ciphertext of the encrypted first private key may be obtained by encrypting the first private key using a second public key. The second private key and the second public key may belong to a key pair.

In some embodiments, encrypting the first private key may include encrypting the first private key in a network-isolated environment.

In some embodiments, the second private key and the second public key may be generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some embodiments, the symmetric key may be used in subsequent encrypted data transmission between the client terminal and a server.

The present disclosure is also directed to an HTTPS-based packet processing apparatus as follows:

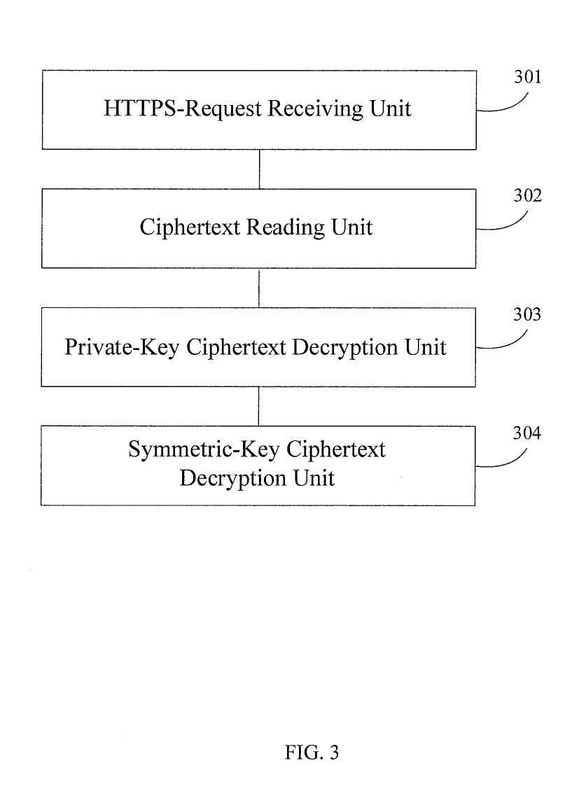

An HTTPS-based packet processing apparatus may be described below with reference to the accompanying drawing. FIG. 3 is a schematic diagram of an exemplary HTTPS-based packet processing apparatus, according to some embodiments of the present disclosure.

The HTTPS-based packet processing apparatus may include operations similar to the above described HTTPS-based packet processing methods. Thus, the HTTPS-based packet processing apparatus may be described below in a simple way. More details of those related parts may refer to the above descriptions for the HTTPS-based packet processing methods.

An HTTPS-based packet processing apparatus may include:

An HTTPS-request receiving unit 301 configured to receive an HTTPS request sent by a client terminal.

A ciphertext reading unit 302 configured to look up in a key database in accordance with a target domain name in the HTTPS request, and read a ciphertext of an encrypted first private key corresponding to the target domain name.

A private-key ciphertext decryption unit 303 configured to decrypt, by using a second private key, the ciphertext of the encrypted first private key to obtain the first private key.

A symmetric-key ciphertext decryption unit 304 configured to decrypt, by using the first private key, a ciphertext of an encrypted symmetric key contained in the HTTPS request to obtain the symmetric key.

In general, the units used herein (and any corresponding sub-units), can be a packaged functional hardware unit designed for use with other components (e.g., portions of an integrated circuit) or a part of a program (stored on a computer readable medium) that performs a particular function of related functions. The units can have entry and exit points and can be written in a programming language, such as, for example, Java, Lua, C or C++. A software unit can be compiled and linked into an executable program, installed in a dynamic link library, or written in an interpreted programming language such as, for example, BASIC, Perl, or Python. It will be appreciated that software units can be callable from other units or from themselves, and/or can be invoked in response to detected events or interrupts. Software units configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware units can be comprised of connected logic units, such as gates and flip-flops, and/or can be comprised of programmable units, such as programmable gate arrays or processors. The units or computing device functionality described herein are preferably implemented as software modules, but can be represented in hardware or firmware. Generally, the units described herein refer to logical units that can be combined with other units or divided into sub-units despite their physical organization or storage.

The present disclosure also relates to another HTTPS-based packet processing method as follows:

On the basis of the above HTTPS-based packet processing method, another HTTPS-based packet processing method may be described below with reference to the accompanying drawing.

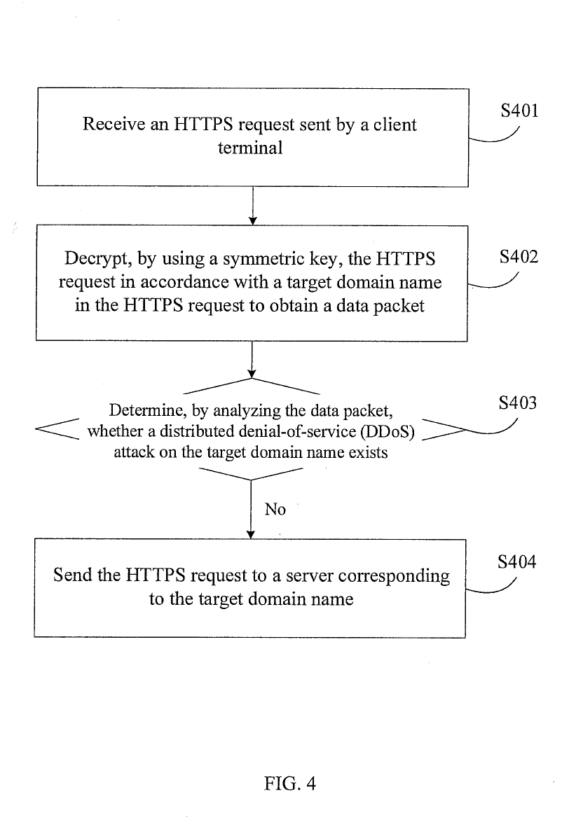

FIG. 4 is a flowchart of another exemplary HTTPS-based packet processing method, according to some embodiments of the present disclosure. Relationships among steps of the another HTTPS-based packet processing method may be determined according to FIG. 4.

The HTTPS-based packet processing method shown in FIG. 4 may include operations similar to the above described HTTPS-based packet processing methods. Thus, the HTTPS-based packet processing method may be described below in a simple way. More details of those related parts may refer to the above descriptions for the HTTPS-based packet processing methods.

Step S401: Receive an HTTPS request sent by a client terminal.

The firewall of the server may carry out the HTTPS-based packet processing method. Nonetheless, in practical applications, the HTTPS-based packet processing method may not be limited to being carried out by the firewall, but may also be carried out by many types of execution entities. For example, an intrusion detection system (IDS) configured on the server may carry out the HTTPS-based packet processing method. When determining whether the HTTPS request sent by the client terminal is an attack, the HTTPS request sent by the client terminal may be decrypted by using the symmetric key obtained through the above described HTTPS-based packet processing method. Whether the HTTPS request is an attack may be determined by analyzing a data packet obtained after the decryption. Various entities that carry out the HTTPS-based packet processing method may change some details, and may not depart from the main concepts of the method disclosed in the present disclosure. Therefore, those various entities that carry out the method and those implementation variants are still in the scope of the present disclosure.

The HTTPS-based packet processing method may be implemented based on the above described HTTPS-based packet processing method. In other words, the symmetric key obtained through the above described HTTPS-based packet processing method may be used to decrypt the HTTPS request sent by the client terminal to the server. The HTTPS request sent from outside of the firewall to the inside of the firewall may be decrypted accordingly. A data packet obtained after the decryption may be analyzed to determine whether the target domain name visited by the HTTPS request suffers from a DDoS attack. According to the determination results, the method may further include certain steps to deal with the situation, thus improving the security of the server for a client website in the firewall.

In some embodiments, the HTTPS request may include a request for data access sent by the client terminal to the server behind the firewall, and may also include data uploaded by the client terminal to the server in the firewall. For example, the HTTPS request may include an operation request for acquiring goods detailed information sent by a browser, installed in an operating system of a smartphone or a personal computer, to a server of an electronic mall in a firewall. As another example, the HTTPS request may include an operation request for uploading account information to the server of the electronic mall in the firewall.

In some embodiments, before this step, the method may also include determining whether a request type of the data request sent by the client terminal is an HTTPS request based on the HTTPS. The method may further include performing a release, interception, or screening operation in accordance with the determination result. Determining the request type of the data request may include the following steps.

The method may include receiving a data request sent by the client terminal. The method may also include determining whether a request type of the data request is the HTTPS request. In response to the request type of the data request is the HTTPS request, the method may include receiving the HTTPS request sent by the client terminal. In response to the request type of the data request is not the HTTPS request, the method may include prohibiting the data request from visiting the target domain name, or intercepting the data request.

Step S402: Decrypt, by using a symmetric key, the HTTPS request in accordance with a target domain name in the HTTPS request to obtain a data packet.

It should be noted that the symmetric key used in this step may be the symmetric key obtained through the above described HTTPS-based packet processing method. The symmetric key may be obtained by decrypting the ciphertext of the encrypted symmetric key sent by the client terminal by using a first private key. The first private key may be obtained by looking up and reading, in a key database, the ciphertext of the encrypted first private key corresponding to the target domain name, and by decrypting the ciphertext of the encrypted first private key by using a second private key. More detailed descriptions about the symmetric key may refer to the above described HTTPS-based packet processing method.

In some embodiments, the HTTPS-based packet processing method may be performed by a firewall.

In some embodiments, the ciphertext of the encrypted first private key may be obtained by encrypting the first private key using a second public key. The second private key and the second public key may belong to a key pair.

In some embodiments, encrypting the first private key may include encrypting the first private key in a network-isolated environment.

In some embodiments, the second private key and the second public key may be generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In accordance with the target domain name visited by the HTTPS request received in Step S401 and by using the symmetric key obtained through the above described HTTPS-based packet processing method, the method may include decrypting the HTTPS request to obtain the data packet. In some embodiments, the data packet may include visiting parameters for the target domain name. In some embodiments, visiting parameters may include traffic, a visitor IP address, and/or visiting frequency.

Step S403: Determine, by analyzing the data packet, whether a distributed denial-of-service (DDoS) attack on the target domain name exists.

According to the data packet obtained by the decryption in Step S402, the method may include determining whether a DDoS attack on the target domain name exist by analyzing the data packet. In response to the DDoS attack on the target domain name exists, the method may include intercepting the HTTPS request. In response to the DDoS attack on the target domain name not occurring, the method may include, as shown in step S404 below, sending the HTTPS request to a server corresponding to the target domain name. In some embodiments, when the DDoS attack on the target domain name exists, the method may also include sending a prompting message of the existence of the DDoS attack. In some embodiments, when the method may include intercepting the HTTPS request, the method may also include sending a prompting message of the existence of the DDoS attack.

As described above, the data packet may include the visiting parameters for the target domain name. In some embodiments, the visiting parameter may include traffic, a visitor IP address, and/or access frequency. According to these parameters, the method may include determining whether the DDoS attack on the target domain name exists as follows:

1) Determining whether the traffic visiting the target domain name in a first time interval is greater than a traffic threshold. In response to the traffic visiting the target domain name in the first time interval being greater than the traffic threshold, the method may further include intercepting the HTTPS request, and/or sending a prompting message of the existence of the DDoS attack. In response to the traffic visiting the target domain name in the first time interval being not greater than the traffic threshold, the method may include sending the HTTPS request to the server corresponding to the target domain name, as shown in step S404 below.

2) Determining whether the visiting frequency from the visitor IP address to the target domain name in a second time interval is greater than a visiting frequency threshold. In response to the visiting frequency from the visitor IP address to the target domain name in the second time interval being greater than the visiting frequency threshold, the method may include intercepting the HTTPS request, and/or sending a prompting message of the existence of the DDoS attack. In response to the visiting frequency from the visitor IP address to the target domain name in the second time interval being not greater than the visiting frequency threshold, the method may include sending the HTTPS request to the server corresponding to the target domain name, as shown in step S404 below.

In some embodiments, various implementation approaches may be employed to determine whether the DDoS attack on the target domain name exists. For example, the method may include determining whether the DDoS attack on the target domain name exists in accordance with other visiting parameters contained in the data packet. The method may also include performing certain operations based on the determination results. Those various approaches to determining whether the DDoS attack on the target domain name exists may include some differences from each other, and may not be considered as methods different from the present disclosure, and therefore are in the protection scope of the present disclosure.

Step S404: Send the HTTPS request to a server corresponding to the target domain name.

On the premise that no DDoS attack on the target domain name determined in step 403, the method may further include this step. The method may include sending the HTTPS request to the server corresponding to the target domain name. The server may perform a corresponding operation accordingly.

The HTTPS-based packet processing method may include, after receiving the HTTPS request sent by the client terminal, decrypting the received HTTPS request by using the symmetric key obtained by the above described HTTPS-based packet processing method. The method may also include determining, by analyzing the data packet obtained after the decryption, whether a DDoS attack on the target domain name exists. In response to no DDoS attack on the target domain name existing, the method may include sending the HTTPS request to the server corresponding to the target domain name. The HTTPS-based packet processing method may further include the above described HTTPS-based packet processing method to reduce the risk of leaking a private key for a client. In some embodiments, the data packet obtained by decrypting the HTTPS request may be analyzed to determine whether a DDoS attack on the target domain name exists. It may prevent a DDoS attack caused by an illegal HTTPS request, and may enhance the security of the website domain name.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

The present disclosure is also directed to another HTTPS-based packet processing apparatus as follows:

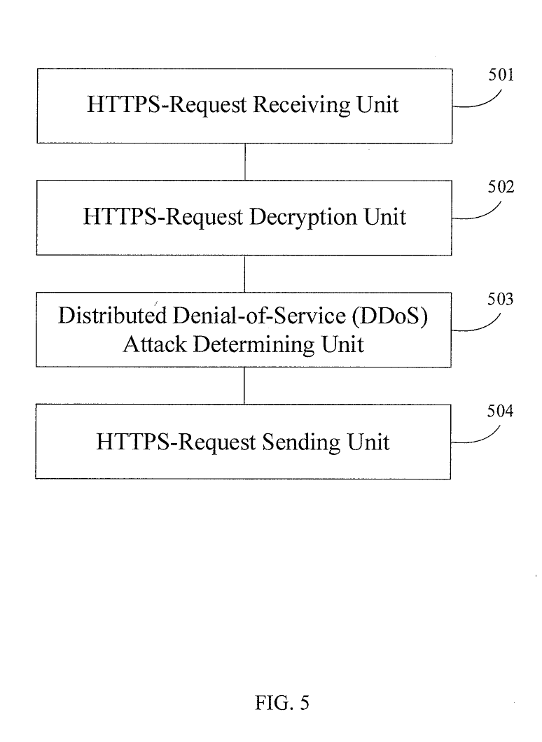

An HTTPS-based packet processing apparatus may be described below with reference to the accompanying drawing. FIG. 5 is a schematic diagram of another exemplary HTTPS-based packet processing apparatus, according to some embodiments of the present disclosure.

The HTTPS-based packet processing apparatus may include operations similar to the above described HTTPS-based packet processing methods. Thus, the HTTPS-based packet processing apparatus may be described below in a simple way. More details of those related parts may refer to the above descriptions for the HTTPS-based packet processing methods.

Another HTTPS-based packet processing apparatus may include:

An HTTPS-request receiving unit 501 configured to receive an HTTPS request sent by a client terminal.

An HTTPS-request decryption unit 502 configured to decrypt, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name; decrypting, by using a second private key, the ciphertext of the encrypted first private key to obtain the first private key; and decrypting, by using the first private key, a ciphertext of the encrypted symmetric key sent by the client terminal.

A distributed denial-of-service (DDoS) attack determining unit 503 configured to determine, by analyzing the data packet, whether a DDoS attack on the target domain name exists. In response to that the DDoS attack on the target domain name does not exist, the DDOS attack determining unit 503 may also be configured to activate an HTTPS-request sending unit 504.

The HTTPS-request sending unit 504 configured to send the HTTPS request to a server corresponding to the target domain name.

In some embodiments, if the determination results output from the DDoS attack determining unit 503 is that the DDoS attack on the target domain name exists, the apparatus may further include an HTTPS-request interception unit and/or a prompt unit. The HTTPS-request interception unit may be configured to intercept the HTTPS request. The prompt unit may be configured to send a prompting message of the existence of the DDoS attack.

In some embodiments, the data packet may include visiting parameters for the target domain name. In some embodiments, the visiting parameters may include traffic, a visitor IP address, and/or access frequency.

In some embodiments, the DDoS attack determining unit 503 may include:

A traffic determination subunit configured to determine whether traffic visiting the target domain name in a time interval is greater than a traffic threshold. In response to that the traffic visiting the target domain name in a time interval is not greater than the traffic threshold, the HTTPS-request sending unit 504 may be activated.

In some embodiments, the DDoS attack determining unit 503 may include:

A visiting-frequency determination subunit configured to determine whether visiting frequency from a visitor IP address to the target domain name in a time interval is greater than a visiting frequency threshold. In response to that the visiting frequency from the visitor IP address to the target domain name in the second time interval is not greater than the visiting frequency threshold, the HTTPS-request sending unit 504 may be activated.

In some embodiments, the HTTPS-based packet processing apparatus may also include:

A data-request receiving unit configured to receive a data request sent by the client terminal.

A data-request-type determination unit configured to determine whether a request type of the data request is the HTTPS request. In response to that the request type of the data request is the HTTPS request, HTTPS-request receiving unit 501 may be activated. In response to that the request type of the data request is not the HTTPS request, the HTTPS-based packet processing apparatus may further include a data-request prohibiting unit and/or a data-request interception unit. The data-request prohibiting unit may be configured to prohibit the data request from visiting the target domain name. The data-request interception unit may be configured to intercept the data request.

The present disclosure is also directed to a non-transitory computer readable medium that stores a set of instructions that is executable by at least one processor of an apparatus to cause the apparatus to perform a hypertext transfer protocol secure (HTTPS) based packet processing method. The method may be as one of the above described HTTPS-based packet processing methods referring to FIG. 2. For example, the method may include receiving an HTTPS request sent by a client terminal. The method may also include looking up in a key database in accordance with a target domain name in the HTTPS request, and reading a ciphertext of an encrypted first private key corresponding to the target domain name. The method may further include decrypting, by using a second private key, the ciphertext of the encrypted first private key to obtain the first private key, and decrypting, by using the first private key, a ciphertext of an encrypted symmetric key contained in the HTTPS request to obtain the symmetric key.

In some embodiments, the method in the non-transitory computer readable medium may be performed by a firewall.

In some embodiments, the ciphertext of the encrypted first private key may be obtained by encrypting the first private key using a second public key. The second private key and the second public key may belong to a key pair.

In some embodiments, encrypting the first private key may include encrypting the first private key in a network-isolated environment.

In some embodiments, the second private key and the second public key may be generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some embodiments, the symmetric key may be used in subsequent encrypted data transmission between the client terminal and a server.

The present disclosure is also directed to another non-transitory computer readable medium that stores a set of instructions that is executable by at least one processor of an apparatus to cause the apparatus to perform another hypertext transfer protocol secure (HTTPS) based packet processing method. The method may be as one of the above described HTTPS-based packet processing methods referring to FIG. 4. For example, the method may include receiving an HTTPS request sent by a client terminal. The method may also include decrypting, by using a symmetric key, the HTTPS request in accordance with a target domain name in the HTTPS request to obtain a data packet. The symmetric key may be obtained through: looking up in a key database, and reading a ciphertext of an encrypted first private key corresponding to the target domain name, decrypting, by using a second private key, the ciphertext of the encrypted first private key to obtain the first private key, and decrypting, by using the first private key, a ciphertext of the encrypted symmetric key sent by the client terminal. The method may further include determining, by analyzing the data packet, whether a distributed denial-of-service (DDoS) attack on the target domain name exists. Responsive to the determination that the DDoS attack on the target domain name does not exist, the method may include sending the HTTPS request to a server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, responsive to the determination that the DDoS attack on the target domain name exists, determining whether the DDoS attack on the target domain name exists in the method may further include intercepting the HTTPS request, or sending a prompting message of the existence of the DDoS attack.

In some embodiments, the data packet may include visiting parameters for the target domain name. The visiting parameters may include traffic, a visitor IP address, and a visiting frequency.

In some embodiments, determining whether the DDoS attack on the target domain name exists in the method may include determining whether the traffic visiting the target domain name in a first time interval is greater than a traffic threshold. Responsive to the determination that the traffic visiting the target domain name in the first time interval is not greater than the traffic threshold, determining whether the DDoS attack on the target domain name exists in the method may also include sending the HTTPS request to the server corresponding to the target domain name.

In some embodiments, determining whether the DDoS attack on the target domain name exists in the method may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists in the method may also include sending the HTTPS request to the server corresponding to the target domain name.

In some embodiments, receiving the HTTPS request sent by the client terminal may further include receiving a data request sent by the client terminal. Receiving the HTTPS request sent by the client terminal may also include determining whether a request type of the data request is the HTTPS request. Responsive to the determination that the request type of the data request is not the HTTPS request, receiving the HTTPS request sent by the client terminal may further include prohibiting the data request from visiting the target domain name, or intercepting the data request.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

The present disclosure is also directed to a network apparatus as follows:

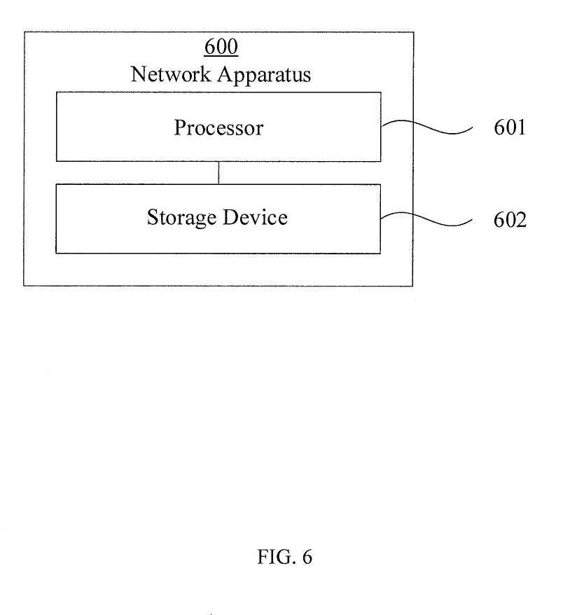

A network apparatus may be described below with reference to the accompanying drawing to carry out the above described HTTPS-based packet processing methods. FIG. 6 is a schematic diagram of an exemplary network apparatus 600, according to some embodiments of the present disclosure.

Network apparatus 600 may include operations similar to the above described HTTPS-based packet processing methods. Thus, network apparatus 600 may be described below in a simple way. More details of those related parts may refer to the above descriptions for the HTTPS-based packet processing methods.

Network apparatus 600 may include a processor 601 and a storage device 602.

Processor 601 may be configured to receive a hypertext transfer protocol secure (HTTPS) request sent by a client terminal. Processor 601 may also be configured to look up in a key database in accordance with a target domain name in the HTTPS request, and read a ciphertext of an encrypted first private key corresponding to the target domain name. Processor 601 may further be configured to decrypt, by using a second private key, the ciphertext of the encrypted first private key to obtain the first private key. In addition, processor 601 may be configured to decrypt, by using the first private key, a ciphertext of an encrypted symmetric key contained in the HTTPS request to obtain the symmetric key.

Storage device 602 may be configured to store the ciphertext of the encrypted first private key and the ciphertext of the encrypted symmetric key.

In some embodiments, storage device 602 may include a memory, and the memory may be configured to store the second private key, the first private key, and/or the symmetric key.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In some embodiments, the symmetric key may be used for subsequent encrypted data transmissions between the client terminal and a server.

The present disclosure is also directed to another network apparatus as follows:

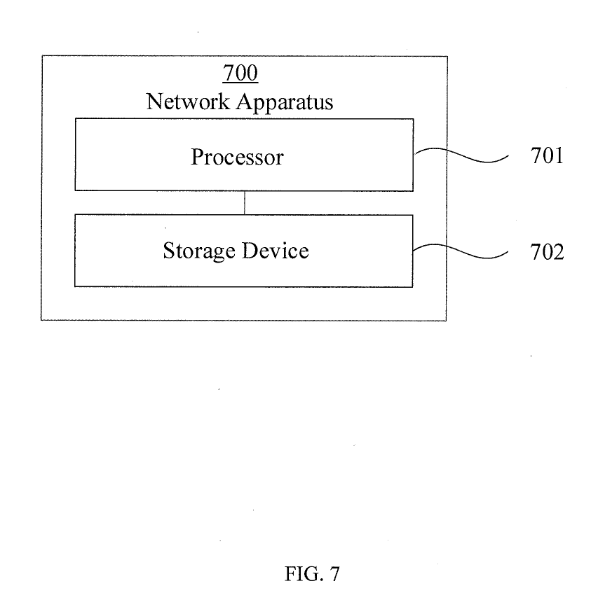

A network apparatus may be described below with reference to the accompanying drawing to carry out the above described HTTPS-based packet processing methods. FIG. 7 is a schematic diagram of another exemplary network apparatus 700, according to some embodiments of the present disclosure.

Network apparatus 700 may include operations similar to the above described HTTPS-based packet processing methods. Thus, network apparatus 700 may be described below in a simple way. More details of those related parts may refer to the above descriptions for the HTTPS-based packet processing methods.

Network apparatus 700 may include a processor 701 and a storage device 702.

Processor 701 may be configured to receive a hypertext transfer protocol secure (HTTPS) request sent by a client terminal Processor 701 may also be configured to decrypt the HTTPS request by using a symmetric key in accordance with a target domain name in the HTTPS request to obtain a data packet. Processor 701 may further be configured to determine, by analyzing the data packet, whether a distributed denial-of-service (DDoS) attack on the target domain name exists. In response to that the DDoS attack on the target domain name does not exist, processor 701 may be configured to send the HTTPS request to a server corresponding to the target domain name. The symmetric key may be obtained through: looking up in a key database, and reading a ciphertext of an encrypted first private key corresponding to the target domain name; decrypting, by using a second private key, the ciphertext of the encrypted first private key to obtain the first private key; and decrypting, by using the first private key, a ciphertext of the encrypted symmetric key sent by the client terminal.

Storage device 702 may be configured to store the target domain name, the data packet, the ciphertext of the encrypted first private key, and/or the ciphertext of the encrypted symmetric key.

In some embodiments, responsive to the DDoS attack on the target domain name existings, determining whether the DDoS attack on the target domain name exists may further include intercepting the HTTPS request, or sending a prompting message of the existence of the DDoS attack.

In some embodiments, the data packet may include visiting parameters for the target domain name. The visiting parameters may include traffic, a visitor IP address, and a visiting frequency.

In some embodiments, determining whether the DDoS attack on the target domain name exists may include determining whether the traffic visiting the target domain name in a first time interval is greater than a traffic threshold. Responsive to the determination that the traffic visiting the target domain name in the first time interval is not greater than the traffic threshold, determining whether the DDoS attack on the target domain name exists may also include sending the HTTPS request to the server corresponding to the target domain name.

In some embodiments, determining whether the DDoS attack on the target domain name exists may include determining whether the visiting frequency from the visitor IP address to the target domain name in a second time interval is greater than a visiting frequency threshold. Responsive to the determination that the visiting frequency from the visitor IP address to the target domain name in the second time interval is not greater than the visiting frequency threshold, determining whether the DDoS attack on the target domain name exists may also include sending the HTTPS request to the server corresponding to the target domain name.

In some embodiments, the network apparatus being configured to receive the HTTPS request sent by the client terminal may include being configured to receive a data request sent by the client terminal. The network apparatus may also be configured to determine whether a request type of the data request is the HTTPS request. Responsive to the determination that the request type of the data request is not the HTTPS request, the network apparatus may also configured to prohibit the data request from visiting the target domain name, or intercept the data request.

In some embodiments, the ciphertext of the encrypted first private key may be obtained by encrypting the first private key using a second public key. The second private key and the second public key may belong to a key pair.

In some embodiments, encrypting the first private key in the method may include encrypting the first private key in a network-isolated environment.

In some embodiments, the second private key and the second public key may by generated by an encrypter.

In some embodiments, the second public key may be output to a control terminal from the encrypter, and may be obtained from the control terminal before encrypting the first private key.

In some embodiments, the ciphertext of the encrypted first private key may be obtained from the control terminal, and may be stored in the key database by the control terminal.

In some embodiments, a unique correspondence may exist between the target domain name, the second private key, and the second public key.

In a typical configuration, a computing device may include one or more central processing units (CPUs), an input/output interface, a network interface, and a memory.

The memory may include computer readable media, such as a volatile memory, a random access memory (RAM), and/or a non-volatile memory. For example, a read-only memory (ROM) or a flash RAM may be the memory. The memory may be an example of a computer readable medium.

The computer readable medium may include non-volatile and volatile media as well as removable and non-removable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission medium, and may be used to store information accessible to a computation device. According to the definition in the present disclosure, the computer readable medium does not include transitory media, such as modulated data signals and carriers.

Persons skilled in the art should understand that the embodiments of the present application may be provided as a method, a system, or a computer program product. Therefore, the present application may be implemented as a complete hardware embodiment, a complete software embodiment, or an embodiment combining software and hardware. Moreover, the present application may be a computer program product implemented on one or more computer-usable storage media (including, but not limited to, a magnetic disk memory, a CD-ROM, an optical memory, and the like) including computer usable program code.

The HTTPS-based packet processing methods and apparatuses are disclosed above, but not limited to these methods and apparatuses. It is appreciated that changes and modifications can be made without departing from the spirit and scope of the present disclosure. Therefore, the scope of the present application should be subject to the scope defined by the claims of the present application.

What is claimed is:

1. A hypertext transfer protocol secure (HTTPS) based packet processing method, comprising:
receiving an HTTPS request sent by a client terminal;
obtaining a ciphertext of an encrypted first private key corresponding to a target domain name based on a look up using the target domain name in the HTTPS request;
decrypting, by using a second private key, the ciphertext of the encrypted first private key to obtain the first private key; and
decrypting, by using the first private key, a ciphertext of an encrypted symmetric key contained in the HTTPS request to obtain the symmetric key.

2. The HTTPS-based packet processing method according to claim 1, wherein the HTTPS-based packet processing method is performed by a firewall.

3. The HTTPS-based packet processing method according to claim 1,
wherein the ciphertext of the encrypted first private key is obtained by encrypting the first private key using a second public key,
wherein the second private key and the second public key belong to a key pair.

4. The HTTPS-based packet processing method according to claim 3,
wherein encrypting the first private key includes encrypting the first private key in a network-isolated environment.

5. The HTTPS-based packet processing method according to claim 3,
wherein the second private key and the second public key are generated by an encrypter.

6. The HTTPS-based packet processing method according to claim 5,
wherein the second public key is output to a control terminal from the encrypter, and is obtained from the control terminal before encrypting the first private key.

7. The HTTPS-based packet processing method according to claim 6,
wherein the ciphertext of the encrypted first private key is obtained from the control terminal, and is stored in the key database by the control terminal.

8. The HTTPS-based packet processing method according to claim 3,
wherein a unique correspondence exists between the target domain name, the second private key, and the second public key.

9. The HTTPS-based packet processing method according to claim 1,
wherein the symmetric key is used in subsequent encrypted data transmission between the client terminal and a server.

10. A hypertext transfer protocol secure (HTTPS) based packet processing apparatus, comprising:
an HTTPS-request receiving unit configured to receive an HTTPS request sent by a client terminal;
a ciphertext reading unit configured to obtain a ciphertext of an encrypted first private key corresponding to a target domain name based on a look up using the target domain name in the HTTPS request;
a private-key ciphertext decryption unit configured to decrypt, by using a second private key, the ciphertext of the encrypted first private key to obtain the first private key; and
a symmetric-key ciphertext decryption unit configured to decrypt, by using the first private key, a ciphertext of an encrypted symmetric key contained in the HTTPS request to obtain the symmetric key.

11. A hypertext transfer protocol secure (HTTPS) based packet processing method, comprising:
receiving an HTTPS request sent by a client terminal;
decrypting, by using a symmetric key, the HTTPS request in accordance with a target domain name in the HTTPS request to obtain a data packet, wherein the symmetric key is obtained through:
obtaining a ciphertext of an encrypted first private key corresponding to the target domain name based on a look up using the target domain name in the HTTPS request,
decrypting, by using a second private key, the ciphertext of the encrypted first private key to obtain the first private key, and
decrypting, by using the first private key, a ciphertext of the encrypted symmetric key sent by the client terminal;
determining, by analyzing the data packet, whether a distributed denial-of-service (DDoS) attack on the target domain name exists; and
responsive to the determination, sending the HTTPS request to a server corresponding to the target domain name.

12. The HTTPS-based packet processing method according to claim 11, wherein responsive to the determination, sending the HTTPS request includes:
responsive to the determination that the DDoS attack on the target domain name does not exist, sending the HTTPS request to the server corresponding to the target domain name.

13. The HTTPS-based packet processing method according to claim 11, wherein determining, by analyzing the data packet, whether the DDoS attack on the target domain name exists further includes:
responsive to the determination that the DDoS attack on the target domain name exists,
intercepting the HTTPS request; or
sending a prompting message of the existence of the DDoS attack.

14. The HTTPS-based packet processing method according to claim 11,
wherein the data packet includes visiting parameters for the target domain name,
wherein the visiting parameters includes traffic, a visitor IP address, and a visiting frequency.

15. The HTTPS-based packet processing method according to claim 14, wherein determining whether the DDoS attack on the target domain name exists includes:
determining whether the traffic visiting the target domain name in a first time interval is greater than a traffic threshold; and
responsive to the determination that the traffic visiting the target domain name in the first time interval is not greater than the traffic threshold, sending the HTTPS request to the server corresponding to the target domain name.

16. The HTTPS-based packet processing method according to claim 14, wherein determining whether the DDoS attack on the target domain name exists includes:
determining whether the visiting frequency from the visitor IP address to the target domain name in a second time interval is greater than a visiting frequency threshold; and
responsive to the determination that the visiting frequency from the visitor IP address to the target domain name in the second time interval is not greater than the visiting frequency threshold, sending the HTTPS request to the server corresponding to the target domain name.

17. The HTTPS-based packet processing method according to claim 11, wherein receiving the HTTPS request sent by the client terminal further includes:
receiving a data request sent by the client terminal;
determining whether the data request includes the HTTPS request;
responsive to the determination that the data request does not include the HTTPS request, prohibiting the data request from visiting the target domain name, or intercepting the data request.

18. The HTTPS-based packet processing method according to claim 11,
wherein the ciphertext of the encrypted first private key is obtained by encrypting the first private key using a second public key,
wherein the second private key and the second public key belong to a key pair.

19. The HTTPS-based packet processing method according to claim 18,
wherein encrypting the first private key includes encrypting the first private key in a network-isolated environment.

20. The HTTPS-based packet processing method according to claim 18,
wherein the second private key and the second public key are generated by an encrypter.

21. The HTTPS-based packet processing method according to claim 20,
wherein the second public key is output to a control terminal from the encrypter, and is obtained from the control terminal before encrypting the first private key.

22. The HTTPS-based packet processing method according to claim 21,
wherein the ciphertext of the encrypted first private key is obtained from the control terminal, and is stored in the key database by the control terminal.

23. The HTTPS-based packet processing method according to claim 11,
wherein a unique correspondence exists between the target domain name, the second private key, and the second public key.

24. A non-transitory computer readable medium that stores a set of instructions that is executable by at least one processor of an apparatus to cause the apparatus to perform a hypertext transfer protocol secure (HTTPS) based packet processing method, the method comprising:
receiving an HTTPS request sent by a client terminal;
obtaining a ciphertext of an encrypted first private key corresponding to a target domain name based on a look up using the target domain name in the HTTPS request;
decrypting, by using a second private key, the ciphertext of the encrypted first private key to obtain the first private key; and
decrypting, by using the first private key, a ciphertext of an encrypted symmetric key contained in the HTTPS request to obtain the symmetric key.

25. The non-transitory computer-readable medium of claim 24,
wherein the HTTPS-based packet processing method is performed by a firewall.

26. The non-transitory computer-readable medium of claim 24,
wherein the ciphertext of the encrypted first private key is obtained by encrypting the first private key using a second public key,
wherein the second private key and the second public key belong to a key pair.

27. The non-transitory computer-readable medium of claim 26,
wherein encrypting the first private key includes encrypting the first private key in a network-isolated environment.

28. The non-transitory computer-readable medium of claim 26,
wherein the second private key and the second public key are generated by an encrypter.

29. The non-transitory computer-readable medium of claim 28,
wherein the second public key is output to a control terminal from the encrypter, and is obtained from the control terminal before encrypting the first private key.

30. The non-transitory computer-readable medium of claim 29,
wherein the ciphertext of the encrypted first private key is obtained from the control terminal, and is stored in the key database by the control terminal.

31. The non-transitory computer-readable medium of claim 26,
wherein a unique correspondence exists between the target domain name, the second private key, and the second public key.

32. The non-transitory computer-readable medium of claim 24,
wherein the symmetric key is used in subsequent encrypted data transmission between the client terminal and a server.

33. A non-transitory computer readable medium that stores a set of instructions that is executable by at least one processor of an apparatus to cause the apparatus to perform a hypertext transfer protocol secure (HTTPS) based packet processing method, the method comprising:
receiving an HTTPS request sent by a client terminal;
decrypting, by using a symmetric key, the HTTPS request in accordance with a target domain name in the HTTPS request to obtain a data packet, wherein the symmetric key is obtained through:
obtaining a ciphertext of an encrypted first private key corresponding to the target domain name based on a look up using the target domain name in the HTTPS request,
decrypting, by using a second private key, the ciphertext of the encrypted first private key to obtain the first private key, and
decrypting, by using the first private key, a ciphertext of the encrypted symmetric key sent by the client terminal;
determining, by analyzing the data packet, whether a distributed denial-of-service (DDoS) attack on the target domain name exists; and
responsive to the determination, sending the HTTPS request to a server corresponding to the target domain name.
